(19) United States
(12) Patent Application Publication
(10) Pub. No.: US 2014/0265330 A1
(43) Pub. Date: Sep. 18, 2014

(54) METHOD AND SYSTEM FOR AUTOMATICALLY STOPPING A WIND TURBINE

(71) Applicant: PANACIS INC., Ottawa (CA)

(72) Inventor: Steve Carkner, Ottawa (CA)

(73) Assignee: PANACIS INC., Ottawa (CA)

(21) Appl. No.: 14/355,400

(22) PCT Filed: Oct. 5, 2012
(86) PCT No.: PCT/IB2012/055350

§ 371 Date: Apr. 30, 2014

Related U.S. Application Data
(60) Provisional application No. 61/553,921, filed on Oct. 31, 2011.

(51) Int. Cl. H02J 7/00; F03D 9/02; F03D 7/02; H02P 3/12

(52) U.S. Cl. CPC H02J 7/0031; H02P 3/12; F03D 9/021; F03D 7/0272; H02J 2007/0037
USPC 290/44

(57) ABSTRACT

A system and method for stopping a wind turbine in a battery charging circuit includes a step to terminate battery charging by opening a first switch between an electrical generator coupled to the wind turbine and the battery. A second switch between the electrical generator output terminals is then closed in order to short the generator, create a drag on the wind turbine and ultimately stop its rotation. The signal to open the first switch is generated by a battery charge monitor which when sensing a full charge on the battery will open the first switch and close the second switch. In another embodiment, there is a wind turbine auto stop signal generator connected to the battery monitor to close the second switch upon receipt of a signal indicating full battery charge from the battery monitor. In yet another embodiment there is a remotely located control computer networked to the battery monitor and the wind turbine auto stop signal generator. In still another embodiment the computer is able to receive data inputs from a variety of sources, such as weather services, to assess conditions dangerous to wind turbine operation.

### TECHNICAL FIELD

This invention relates to the field of wind turbines coupled to an electric generator used to harness wind energy to generate electricity for charging a battery and specifically to a method and system for stopping the rotation of a wind turbine in situations where continue rotation may damage the wind turbine, generator and structural support.

### BACKGROUND ART

Wind turbine generators produce peak energy when they are under moderate load in a specific voltage output band. Most wind turbine generators can be caused to stop rotating and producing power by applying a short circuit to the generator output conductors.

Wind turbine generators should not be left spinning without a load applied to the generator output. Without a load, a wind turbine generator can spin freely and attain speeds sufficiently high to damage the turbine and the generator as well as the supporting structure. The generation of extremely high voltage during a turbine runaway scenario will cause electrical damage to the system.

In a battery charging system where a wind turbine generator is used as the source of charging power batteries are used as the generator load. The batteries have historically been lead-acid, nickel cadmium or nickel-metal-hydride batteries. All of these types of batteries require a constant charging current at low current levels in order to keep them fully charged. Therefore, these batteries provide a constant load to the generator and assist in the control of wind turbine speed even when they are fully charged.

Modern lithium based battery systems cannot withstand a constant charging current. Under a constant charging current the lithium cells will reach dangerously high voltage possibly resulting in thermal run-away, battery damage and fires. Lithium battery chargers designed for wind operation therefore include shunt regulators or load-dumping banks that generate heat so that a constant load is placed on the generator and hence a retarding control on the wind turbine. The shunt regulators and load dumping banks are separate from the lithium battery bank and control charging to the bank as a whole. Diversion regulators can also be used to create a constant load on a wind turbine generator and lithium battery system. These switch the output of the generator from the batteries to a useful load such as a water-heater or hydrogen generator thereby maintaining a constant load on the generator and retarding control on the wind turbine.

All of the above methods and systems of maintaining a load on the wind turbine generator will keep the wind turbine under control under most conditions. However, in very high wind conditions, these methods and systems may fail to place the wind turbine a safe state creating potentially damaging conditions. The methods are also unable to predict future weather or environmental events automatically without direct user intervention.

Therefore, there remains a need for a method and system for putting a wind turbine generator into a safe stop condition when required by environmental, regulatory or financial reasons. There is further a need for a method and system to put a wind turbine generator into a safe stop conditions without excessive heat generation.

### Disclosure of Invention

### Technical Problem

### Solution to Problem

### Technical Solution

The invention has three principle components that taken separately or in different combinations may provide the desired safe control of a wind turbine in a generation system.

Component 1

Charge termination conditions in advanced batteries are often encountered by a battery management system (BMS) due to normal full-charge state of the battery. In this case the BMS will terminate charging of the battery by opening a first switch between the charge source, the wind turbine generator, and the battery. Charge termination events may also occur due to safety concerns that the BMS detects such as thermal, mechanical and electrical faults.

This invention provides a short time delay between a charge termination condition where the first switch between the wind turbine generator and the battery is opened and a wind turbine stop condition where a second switch between the output leads of the generator is closed thereby shorting the generator and causing the wind turbine to slow or stop.

The concept of placing a short circuit on the input of a battery (output of the wind turbine generator), especially a lithium battery, must be carefully thought out because it is not an obvious application of the technology. However, placing a short circuit on the electrical terminals leading to the battery has an advantage when the battery is connected to a wind turbine generator.

Other methods of stopping the wind turbine following the generation of a wind turbine stop signal include deployment of a wind turbine rotor stop pin, pivoting the wind turbine out of the wind and folding the wind turbine blades.

By stopping the wind turbine using a wind turbine stop signal there is no need to maintain a load on the output of the electrical generator. The result is that no significant heat will be generated in the circuitry.

Component 2

Battery communication systems allow advanced lithium battery systems to connect into a communications network such as the Internet, cellular networks and circuit switched wired networks.

Generation of a wind turbine stop signal can therefore be implemented through the communication system as part of the overall power system control scheme. This will allow remote diagnostic, assessment and control of the charging system by stopping the wind turbine remotely.

Generator output, wind-speed and battery conditions can also be used to generate a wind turbine stop condition signal. The wind turbine stop signal may also be generated for non-technical and non-physical reasons such as a financial reason when a power consumer fails to pay a utility bill or when a wind power generator is assessed an over-generation penalty. A wind turbine stop signal may also be generated for ecological reasons, for example, stopping wind turbine rotation due to the seasonal and daily passage of migratory birds.

Component 3

A monitoring and control system can be setup to establish the location of one or more wind turbine generators. The location of thousands of wind turbine generators can be established using a networked computer system.

A networked computer system can access weather information for specific wind turbine generator locations. By monitoring weather at a given wind turbine generator installation site predictions can be made so that a wind turbine stop signal is generated when weather conditions are deemed to be unsafe. A wind turbine resume operation signal can be generated when safe conditions have returned.

### Advantageous Effects of Invention

### Advantageous Effects

### BRIEF DESCRIPTION OF DRAWINGS

### Description of Drawings

FIG. 1 is a block diagram of one embodiment of the invention.

FIG. 2 is a diagram of one embodiment of a continent-wide application of the invention.

### BEST MODE FOR CARRYING OUT THE INVENTION

### Best Mode

In one embodiment of the invention there are only the basic elements of a local battery management system (BMS) controlling the charging of a battery using a single wind turbine generator. The local BMS controls a first switch to disconnect a wind turbine generator from a battery when the BMS determines that charging should cease. The local BMS controls a second switch on the generator output terminals. The second switch receives a wind turbine stop signal in response to a wind turbine stop-condition and closes. By closing the second switch thereby shorting the generator output wires a drag or retarding force is generated on the generator thereby slowing or stopping the wind turbine. If the wind turbine can be slowed to about 10% of its normal running speed then a safe state has been achieved.

In a second embodiment of the invention there is a remotely controlled BMS that communicates with a remote computer system. The BMS provides wind turbine generator and battery charge information to the remote computer system so that the remote computer system can determine if battery charging should stop. If the remote computer system determines that battery state of charge is such that charging should stop then it will send one signal to open a first switch between the wind turbine generator and the battery and it will send a wind turbine stop signal to close a second switch to short the output wires of the generator thereby stopping the wind turbine.

In a third embodiment of the invention the BMS is linked to a networked computer system over a wide geographical area comprising a plurality of wind turbine generator installations. The networked computer system is able to gather and process a plurality of data such as the movement of weather systems. The system is able to control wind turbine generator operation using a variety of factors not related to battery state of charge. For example, if the networked computer system predicts that a weather system will move into a wind turbine generator farm with potentially damaging results, it will send a signal to open a first switch between the battery and the wind turbine generator to cease battery charging and it will send a second wind turbine stop signal to close a second switch between the output wires of the generator thereby creating drag on the wind turbine so that is will slow rotation and stop.

In this description the term ‘switch’ is used to represent any means by which the flow of electrons may be controlled. In addition, the first switch and the second switch may be composed of two separate single-pole-single-throw switches or a single-pole-double-throw switch.

Batteries may be charged from sources other than wind turbine generators, for example, hydro-electric power and photovoltaic power. This invention is intended to control energy generated by wind turbine generators. If solar, hydro and other non-wind sources of energy are also available then the control of those sources will be independent of or in conjunction with the wind turbine generator control schemes described herein.

The wind turbine stop signal is electrical. In this specification the electrical wind turbine stop signal is generated and causes the closing a second switch between the wind turbine generator output wires to create a short circuit which will drag the wind turbine to a halt. The creation of a short circuit between the wind turbine generator output terminals is a common way to stop the rotation of a wind turbine. However, wind turbine generators with built-in electronics and digital control systems can create a wind turbine stop signal that is digital. The method, by which the wind turbine stop signal is generated, regardless of the environmental or battery condition, whether it is a battery full charge, bad weather and animal migration patterns as examples only, is the key focus of this invention.

Implementation of the invention will become more apparent from the detailed description set forth below when taken in conjunction with the drawings, in which like elements bear like reference numerals.

The present invention is described in this description with reference to the Figures, in which like numbers represent the same or similar elements. Reference throughout this specification to ‘one embodiment,’ ‘an embodiment,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practised without one or more of the specific details, or with other methods, components, materials, and so forth. In other instances, well-known structures, materials, or operations are not shown or described in detail to avoid obscuring aspects of the invention.

FIG. 1 shows one embodiment of the invention (100). A battery (101) is used to store energy that is generated by a wind turbine generator (104). The energy from the wind turbine generator enters the battery through a normally closed first switch (103) that controls battery charging. The wind turbine is placed into a safe stop condition by applying a short circuit to the terminals of the wind turbine generator using a second switch (106) that shorts the terminals of the wind turbine generator which in turn creates a drag on the wind turbine slowing its rotation down to a stop.

Different wind turbine generators may use different stop methods to place them into a safe stop condition. These include electric brakes, stop pins and manual tethers. Most prior art stop methods, even those that are electrical, are applied manually at the wind turbine generator site. In our invention, the placement of second switch (106) to short the wind turbine generator output terminals is advantageous because it allows remote control and networking applications heretofore unknown in methods for achieving a wind turbine safe stop. However, placing a shorting second switch (106) across the terminals of a battery (101) is an unusual approach and requires careful consideration and timing as well as a controlled interaction with the battery charging control switch (103) to ensure that the battery itself is never short circuited.

The battery includes a BMS (Battery Monitoring System) (102) which monitors the charge condition of the battery (101) and controls the charging control first switch (103). The BMS also includes a wind turbine auto-stop controller (105) which controls the shorting second switch (106) to stop the wind turbine rotation. The BMS can actuate the first and second switches under any other wind turbine stop condition that is appropriate for the wind turbine generator (104) in use.

The BMS (102) and wind turbine auto-stop controller (105) may be implemented and combined in the same circuitry and software or they may be independent elements.

In one embodiment of the invention, the system is dedicated to a single wind turbine generator and operates independent of other wind turbine generators and control schemes. When the battery (101) reaches a fully charged state or if there is any other reason to stop battery charging, such as excessive battery temperature, the BMS (102) will stop battery charging by sending an open switch signal to first switch (103) thereby disconnecting the battery from the wind turbine generator. The same signal is sent to the wind turbine auto stop controller (105). Sequentially, and after a suitable time period, the wind turbine auto-stop controller (105) will generate a wind turbine stop signal to close second switch (106) to short the output terminals of the wind turbine generator creating drag and slowing and stopping the rotating turbine.

The time delay from the opening of the charging control first switch (102) to the closing of the shorting second switch (106) (or similarly from the opening of the shorting second switch to the closing of the charging control first switch) must be long enough to ensure the battery (101) is never shorted out. This time should also be short enough that the wind turbine generator does not have enough time to ramp up to an unsafe speed during the period of time when the electrical generator is not loaded. The timing is dependent on the type of switch used. A solid-state switch, typically based on a transistor circuit, will be able to open and close in a few micro-seconds or less. In this situation a time delay of perhaps 100 uS may be sufficient. However, a system based on electromechanical relays may require tens or even hundreds of milli-seconds to ensure full switching has occurred. Some relays can implement a single-pole-double-throw configuration which would allow one relay to perform both the charging and shorting function and would have the added benefit that a break-before-make is guaranteed, even if the relay is sticking.

A free-spinning wind turbine may achieve extremely high rotation speeds which can damage the wind turbine, the wind turbine generator and the supporting structures and create unsafe over-voltage conditions. High rotation speeds also leads to premature wear and stress on components of the wind turbine generator. For those reasons it is important that the wind turbine be slowed or stopped when no load is applied. Since the maximum switching time could be several seconds due to the mechanical inertia of the wind turbine generator it is highly improbable that the wind turbine will achieve an unsafe velocity after only a few seconds with no load.

In the event that other loads are present on the wind turbine generator (such as a water heater, power inverter and pumps) then the wind turbine auto-stop controller (105) may open the second switch because these additional loads will be sufficient to keep the wind turbine generator loaded at an appropriate and safe level without the possibility of the wind turbine rotating in an uncontrolled manner.

In another embodiment of the invention, the wind turbine auto-stop controller (105) may include a networked communication link to other sources of information and control. FIG. 1 shows the wind turbine auto-stop controller (105) linked to an Internet cloud (106). This in turn allows a control connection to other electrically linked power generation utilities (107), wildlife management services (108) and weather information services (109). Other data inputs may include billing data with respect to clients who have not paid their bills or power generation data in situations where a particular wind turbine generator has generated more power than permitted by the utility. The information from these sources can be used directly by the wind turbine auto-stop controller (105) to close the second switch (104) to control wind turbine rotation independent of the state of charge of the battery. The information from these sources may also be collected and tracked by a separate computer system (110) where only a subset of information from utilities (111), wildlife management services (112) and weather services (113) will be used, either independently or in combination, to generate and transmit a wind turbine stop signal to the wind turbine auto-stop controller (105) to open first switch (103) and close second switch (106) in order to stop the rotation of the wind turbine.

The utility (107, 111) information is used to determine if the electrical grid is capable of absorbing the energy being generated by the wind turbine generator. If the grid cannot absorb additional wind turbine generated energy the computer system (110) will generate and transmit a wind turbine stop signal to the wind turbine auto stop controller in order to close the second switch and the wind turbine generator off line to maintain a stable electrical grid. The computer system (110) can also be programmed with financial information with respect to rates being paid for electricity generated by a wind turbine generator during certain periods in the day so that the operation of the wind turbine generator can be optimized for a maximum revenue stream. Other information can be programmed into the computer system to control the operation of a wind turbine generator for a variety of reasons whether they are regulatory, financial or operational.

For example, wildlife management services (108, 112) can provide information about animal migration patterns so that these animals are not harmed by wind turbine generators. Time of day information with respect to such migration patterns may also be considered and combined with all other date to determine if a wind turbine stop signal should be generated. The use of these services would allow the owners of the wind turbine generators to find a balance between the environmental damage caused by the spinning blades disrupting migrations and killing animals, and the economic and environmental benefits of generating clean electricity. If animal deaths can be reduced by periodically stopping the wind turbine during peak migration period then electricity can still be generated when animal migrations or movements are at their ebb.

In another example, weather information services (109, 113) provide critical information to the computer system about potentially damaging weather conditions that may enter the location of the wind turbine generator. Real time or prediction-based decisions made by the computer system may require the generation of a wind turbine stop signal so that the wind turbines are placed in a safe state. The advantage is clear in that instead of manually locking down wind turbines, possibly hours or days before a storm hits, the computer system can track a storm's progress and selectively shut-down wind turbines as required thereby optimizing generation time. The wind turbine generators can be instrumented with weather sensors so that they can provide real-time information on weather conditions at the wind turbine generator site to the computer system so that the computer system knows when conditions mandate the issuance of a wind turbine stop signal or allow for the restart of the wind turbines.

FIG. 2 illustrates the geographic control possibilities of a wide area networked system across continental North America (200). Since major weather patterns can affect wind speeds over a large area, the movement of a major storm (202) can be tracked using an appropriate monitoring service and that information provided to the computer system. The geographic locations of the wind turbine generators (203) are individually known by the computer system. As the storm (202) moves towards a specific wind turbine generator location, the computer system can generate a wind turbine stop signal to close switch (106) before the storm hits and a wind turbine restart signal to open switch (106) after the storm moves.

Although FIG. 2 illustrates this concept with a storm (202) any moving environmental condition such as a forest fire or a major bird migration can be tracked and the information fed to the computer system. The computer system can then control the operation of affected wind turbine generators as necessary for safety and optimized power generation. The monitoring system shown in FIG. 2 can be scaled up and down to suit local and regional utilities.

Furthermore, although this description generally relates to wind turbines used to generate electrical power, this invention can be used to control the operation of single or multiple wind turbines used to pump water and other applications where wind turbines are the primary motive force.

### Mode for the Invention

### Mode for Invention

### Industrial Applicability

### Sequence Listing Free Text

Sequence List Text

1. A system for automatically stopping the rotation of a wind turbine coupled to an electrical generator connected to a battery in a battery charging circuit, said system comprising:
a. a first switch in said battery charging circuit disposed between said electrical generator and a battery;
b. a second switch in the battery charging circuit disposed between a set of output terminals on the electrical generator;
c. a battery monitor electrically connected to said battery for generating a battery state of charge signal;
d. wherein said battery monitor is further logically connected to said first switch for open/close operation thereof upon receipt of said battery state of charge signal;
e. a wind turbine auto stop controller for generating a wind turbine stop signal wherein said wind turbine auto stop controller is logically connected to the battery monitor for receiving the battery state of charge signal; and,
f. wherein the wind turbine auto stop controller is further logically connected to said second switch for open/close operation thereof upon receipt of said wind turbine stop signal;
g. so that when the first switch is open the battery is isolated from the electrical generator and when the second switch is closed the electrical generator is shorted thereby dragging said wind turbine to a slow or stopped state.

2. The system of claim 1 wherein the first switch is normally closed and the second switch is normally open and wherein the first switch is opened when the battery state of charge signal indicates a fully charged battery.

3. The system of claim 2 wherein the wind turbine stop signal closes the second switch to short the electrical generator upon receipt of the battery state of charge signal indicating a fully charged battery.

4. The system of claim 3 wherein the first switch has a first open time and the second switch has a second closure time.

5. The system of claim 4 wherein said first open time is prior to said second closure time.

6. The system of claim 5 wherein the second closure time is sufficiently close to the first open time to prevent a battery short circuit and to prevent an uncontrolled acceleration of the wind turbine.

7. The system of claim 5 wherein the battery monitor is logically connected to a remotely located control computer comprising a microprocessor and a software program and wherein said remotely located control computer receives said battery state of charge signal so that when the battery state of charge signal indicates a fully charged battery said microprocessor generates and transmits a first control signal to the battery monitor to open the first switch and a wind turbine stop signal to the wind turbine auto stop controller to close the second switch.

8. The system of claim 7 further including an Internet cloud and the remotely located control computer wherein the wind turbine auto stop controller is connected to said Internet cloud and wherein the remote control computer is also connected to the Internet cloud.

9. The system of claim 8 further including a plurality of data inputs to the remote control computer via the Internet cloud comprising at least one of the following data inputs: a real time condition or predicted condition of a local electrical grid to which the electrical generator is connected; a real time condition or predicted condition of local weather patterns proximate to the wind turbine; and, a real time condition or predicted condition of animal movement patterns proximate to the wind turbine.

10. The system of claim 9 wherein the remote control computer microprocessor receives said data inputs and said software program analyses the data inputs so that when any of the data inputs indicates an actual or predicts a future dangerous condition for the wind turbine the microprocessor will generate and transmit a wind turbine stop signal to the wind turbine auto stop controller.

11. A system for automatically stopping the rotation of a wind turbine coupled to an electrical generator connected to a battery in a battery charging circuit, said system comprising:
a. a first switch in said battery charging circuit disposed between said electrical generator and a battery;
b. a second switch in the battery charging circuit disposed between a set of output terminals on the electrical generator;
c. a battery monitor electrically connected to said battery for generating a battery state of charge signal;
d. wherein said battery monitor is further logically connected to said first switch for open/close operation thereof upon receipt of said battery state of charge signal;
e. a wind turbine auto stop controller for generating a wind turbine stop signal wherein said wind turbine auto stop controller is logically connected to the battery monitor for receiving the battery state of charge signal;
f. a remote controlling computer comprising a microprocessor and a software program;
g. wherein the wind turbine auto stop controller is logically networked to said remote controlling computer by an Internet cloud;
h. wherein the wind turbine auto stop controller is further logically connected to said second switch for open/close operation thereof upon receipt of said wind turbine stop signal;
i. a plurality of data inputs to the remote control computer via the Internet cloud comprising at least one of the following data inputs: a real time condition or predicted condition of a local electrical grid to which the electrical generator is connected; a real time condition or predicted condition of local weather patterns proximate to the wind turbine; and, a real time condition or predicted condition of animal movement patterns proximate to the wind turbine;
j. so that the remote control computer microprocessor receives said data inputs and said software program analyzes the data inputs so that when any of the inputs indicates a dangerous condition for the wind turbine said microprocessor will generate and transmit a wind turbine stop signal to the wind turbine auto stop controller to open the first switch and to close the second switch;
so that when the first switch is open the battery is isolated from the electrical generator and when the second switch is closed the electrical generator is shorted thereby dragging said wind turbine to a slowed or stopped state.

12. A method for automatically stopping the rotation of a wind turbine coupled to an electrical generator having a pair of terminal outputs connected to a battery in a battery charging circuit, said method comprising the following steps:
a. installing a first switch in said battery charging circuit disposed between said electrical generator and a battery;
b. installing a second switch in the battery charging circuit disposed between said set of output terminals on the electrical generator;
c. using a battery monitor electrically connected to said battery for generating a battery state of charge signal;
d. logically connecting said battery monitor to said first switch for open/close operation thereof upon receipt of said battery state of charge signal;
e. using a wind turbine auto stop controller for generating a wind turbine stop signal;
f. logically connecting said wind turbine auto stop controller to the battery monitor for receiving the battery state of charge signal; and,
g. logically connecting the wind turbine auto stop controller to said second switch for open/close operation thereof upon receipt of said wind turbine stop signal.

13. The method of claim 12 wherein when said battery state of charge signal indicates a fully charged battery the battery monitor generates and transmits an open signal to the first switch so that the battery is isolated from the electrical generator.

14. The method of claim 13 wherein contemporaneously with the step of claim 13, the battery monitor transmits the battery state of charge signal to the wind turbine auto stop controller and wherein when the battery state of charge signal indicates said fully charged battery the wind turbine auto stop controller generates a close signal to the second switch thereby shorting said pair of electrical generator output terminals and thereby dragging said wind turbine to a slowed or stopped state.

15. The method of claim 14 wherein when the first switch opens the second switch closes a predetermine period of time after to prevent a battery short circuit and to prevent an uncontrolled acceleration of the wind turbine.

16. The method of claim 12 further including the step of connecting the battery monitor logically to a remotely located control computer comprising a microprocessor and a software program.

17. The method of claim 16 wherein when said remotely located control computer receives a battery state of charge signal indicating a fully charged battery said microprocessor generates and transmits a first control signal to the battery monitor to open the first switch and a second control signal to the wind turbine auto stop controller to close the second switch.

18. The method of 17 wherein the remotely located control computer is logically networked to the wind turbine auto stop controller by an Internet cloud.

19. The method of claim 18 further including the step of inputting a plurality of data to the remote control computer via said Internet cloud comprising at least one of the following data: a real time condition or predicted condition of a local electrical grid to which the electrical generator is connected; a real time condition or predicted condition of local weather patterns proximate to the wind turbine; and, a real time condition or predicted condition of animal movement patterns proximate to the wind turbine.

20. The method of claim 19 further including the step of said microprocessor receiving said data and said software program analysing the data so that when any of the data indicates an existing or predicts a dangerous condition for the wind turbine said microprocessor generates and transmits a wind turbine stop signal to the wind turbine auto stop controller.
